(19) United States
(12) Patent Application Publication
(10) Pub. No.: US 2026/0150078 A1
(43) Pub. Date: May 28, 2026

(54) METHODS AND APPARATUSES FOR SIDELINK POSITIONING

(71) Applicant: Continental Automotive Technologies GmbH, Hannover (DE)

(72) Inventors: Reuben George Stephen, Singapore (SG); David Gonzalez Gonzalez, Egelsbach (DE); Rikin Shah, Langen (DE)

(73) Assignee: Continental Automotive Technologies GmbH, Hannover (DE)

(21) Appl. No.: 19/122,828

(22) PCT Filed: Oct. 20, 2023
(86) PCT No.: PCT/EP2023/079282

§ 371 Date: Apr. 21, 2025

(30) Foreign Application Priority Data
Oct. 20, 2022 (SG) 10202251446M

(51) Int. Cl. H04W 64/00; H04W 92/18

(52) U.S. Cl. CPC H04W 64/00; H04W 92/18

(57) ABSTRACT

Sidelink Positioning in a wireless communication system wherein a base station assigns at least one or more user equipment as at least one anchor for SL positioning based on the evaluation of the base station, whereby the base station checks if the UE should be assigned as anchor, if the first check result is positive the base station sends an indication to UE assigning it as anchor, if the check result is negative the base station checks if the user equipment is currently assigned as anchor, if the second check result is positive the base station sends indication to UE terminating its previous assignment as anchor.

### CROSS-REFERENCE TO RELATED APPLICATIONS

The present application is a National Stage Application under 35 U.S.C. § 371 of International Patent Application No. PCT/EP2023/079282 filed on Oct. 20, 2023, and claims priority from Singapore Patent Application No. 10202251446M filed on Oct. 20, 2022, in the Intellectual Property Office of Singapore, the disclosures of which are herein incorporated by reference in their entireties.

### TECHNICAL FIELD

The present disclosure relates generally to wireless communications and more particularly, to sidelink positioning in wireless communications systems.

### BACKGROUND

Wireless communication systems have developed through various generations, including a first-generation analog wireless phone service (1G), a second-generation (2G) digital wireless phone service (including interim 2.5G networks), a third-generation (3G) high speed data, Internet-capable wireless service and a fourth-generation (4G) service (e.g., LTE or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile access (GSM) variation of TDMA, etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large wireless sensor deployments. Consequently, the spectral efficiency of 5G mobile communications should be significantly enhanced compared to the current 4G standard. Furthermore, signaling efficiencies should be enhanced and latency should be substantially reduced compared to current standards.

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

US 2022150863 A1 discloses a method being performed by a first station and comprises: transmitting a first message including an indication of whether a clock reconfiguration event occurs at the first station; transmitting a first positioning reference signal (PRS); receiving from a second station a second PRS; and transmitting to the second station a second message including a first time when the first PRS is transmitted by the first station and a second time when the second PRS is received by the first station, to enable the second station to determine a roundtrip time (RTT) between the first station and the second station based on the first time, the second time, a third time when the second station receives the first PRS, a fourth time when the second station transmits the second PRS, and the indication.

WO 2022027298 A1 discloses a UE transmits an SL RTT measurement request to at least one UE. The UE communicates (e.g., transmits, receives, or both), with the at least one UE in response to the SL RTT measurement request, an indication of an SL RTT measurement (e.g., Rx-Tx time difference measurement for RTT).

WO 2020256311 A1 discloses a method of operating a first terminal in a wireless communication system. The method comprises: a step for transmitting a first PRS to a second terminal; a step for receiving a second PRS from the second terminal; a step for receiving a first time difference from the second terminal; and a step for determining a location of the first terminal on the basis of the first time difference and a second time difference.

WO 2021188220 A1 discloses a first user equipment (UE) transmits a request to perform a positioning procedure to at least one second UE over a sidelink between the first UE and the at least one second UE, receives, from the at least one second UE over the sidelink, an indication of a set of time resources, frequency resources, or both allocated for the positioning procedure, and transmits at least one positioning reference signal on the set of time and/or frequency resources allocated for the positioning procedure. The second UE receives the request to perform a positioning procedure from the first UE over the sidelink; transmits the request to perform the positioning procedure to a first network entity; receives, from a second network entity, an indication of a set of time resources, frequency resources, or both allocated for the positioning procedure; and transmits the indication to the first UE over the sidelink.

WO 2021167393 A1 discloses a method for performing positioning in a cellular-vehicle to everything (C-V2X) system, and a device therefor. A method for performing positioning in a terminal mounted on a positioning vehicle in a C-V2X communication system according to one aspect may comprise the steps of: measuring a time of flight (ToF) by performing road side unit (RSU) and round trip time (RTT) ranging; determining a positioning mode, wherein the positioning mode includes a self-positioning mode and a cooperative positioning mode; measuring the relative positions of surrounding vehicles by using a sensor provided in the positioning vehicle on the basis of the determined positioning mode being the cooperative positioning mode, and storing first positioning measurement information corresponding to the measured relative positions; selecting a surrounding vehicle on which to perform cooperative positioning; transmitting the first positioning measurement information to the selected surrounding vehicle; receiving second positioning measurement information from the selected surrounding vehicle; and determining the current location of the positioning vehicle on the basis of the first and second positioning measurement information.

WO 2022041130 A1 discloses an apparatus comprising: an interface; a memory; and a processor, communicatively coupled to the interface and the memory, configured to: instruct a node to send a first cellular reference signal to a target UE (user equipment) and to another UE, the node being a cellular-communication node; instruct, via the interface, the target UE to report to the node a first time difference, the first time difference being a first time amount between receipt of the first cellular reference signal by the target UE and transmission of a second cellular reference signal by the target UE; and instruct, via the interface, the other UE to report a second time difference, the second time difference being a second time amount between receipt of the first cellular reference signal by the other UE and receipt of the second cellular reference signal, in a cross-link interference resource, by the other UE.

WO 2021138127 A1 discloses method of positioning performed by a bandwidth-limited UE includes transmitting a first timing measurement signal to at least one proximate premium UE, wherein the at least one proximate premium UE is capable of using more bandwidth than the bandwidth-limited UE, receiving a second timing measurement signal from the at least one proximate premium UE, and determining location information for the bandwidth-limited UE based at least on the first timing measurement signal and the second timing measurement signal.

WO 2021118756 A1 discloses method of positioning performed by a bandwidth-limited UE according to the disclosure includes receiving a first timing measurement signal from at least one proximate UE, wherein the at least one proximate UE is capable of using more bandwidth than the bandwidth-limited UE, and transmitting a second timing measurement signal to the at least one proximate user equipment.

US 2021306979 A1 discloses systems, methods, and devices for sidelink positioning determination and communication. These can employ techniques including obtaining, at a first sidelink-enabled device, data from one or more data sources indicative of one or more criteria for using either round-trip time (RTT)-based positioning of a target node or single-sided (SS)-based positioning of the target node. The techniques also include selecting, with the first sidelink-enabled device, a positioning type from the group may comprise of RTT-based positioning and SS-based positioning, based on the data. The techniques also include sending a message from the first sidelink-enabled device to a second sidelink-enabled device, where the message includes information indicative of the selected positioning type.

WO 2022126496 A1 discloses devices, methods, apparatuses and computer readable storage media of retransmission of sidelink positioning reference signal (PRS). The method comprises transmitting, to a second device, a first sidelink reference signal associated with a positioning or ranging procedure of the first device; and receiving, from the second device, a second sidelink reference signal associated with the positioning or ranging procedure, the second sidelink reference signal comprising information indicating whether the first sidelink reference signal needs to be retransmitted. In this way, the retransmission of the sidelink PRS can be triggered without extra resource consumption and a fast RTT estimation for sidelink ranging and positioning can be achieved.

US 2018098299 A1 discloses a method by which a user equipment (UE) performs ranging in a wireless communication system, comprising the steps of: transmitting a D2D signal in a subframe N by a first UE; receiving the D2D signal in a subframe N+K from a second UE, which has set, as a subframe boundary, a time point at which the D2D signal is received; and measuring, by the first UE, a round trip time (RTT) by detecting a reception time point of the D2D signal transmitted by the second UE.

US 2021377907 A1 discloses techniques for sidelink positioning with a single anchor using distributed antenna systems. A method for determining relative locations of two stations includes determining a first round trip time for positioning reference signals transmitted between a first station and a first antenna of a second station, determining a second round trip time for the positioning reference signals transmitted between the first station and a second antenna of the second station, wherein the first antenna and the second antenna are disposed in different locations proximate to the second station, and determining relative locations of the first station and the second station based at least in part on the first round trip time and the second round trip time.

US 2022244344 A1 discloses a method for supporting joint positioning of a plurality of user equipments (UEs) performed by a location server. The positions of multiple user equipments (UEs) are jointly determined by a location server using positioning measurements from a comment set of positioning reference signals (PRS), which may include downlink (DL) PRS, uplink (UL) PRS, sidelink (SL) PRS, or a combination thereof. The common set of PRS may be selected by the location server, e.g., based on a rough estimate of position of the UEs determined by the location server, a recommendation from the UEs, or a position report from the UEs. Once selected by the location server, an indication of the common set of PRS is sent to the UEs. The common set of PRS, alternatively, may be selected by one or more UEs, e.g., by a controlling UE or consensus, and one or more UEs provide an indication of the common set of PRS to the location server.

US 2021297206 A1 discloses a user equipment (UE) receiving a request to perform a positioning procedure from a target UE over a sidelink between the assisting UE and the target UE, wherein the assisting UE and the target UE are both out of network coverage, determines, based at least on the request, a set of time and/or frequency resources on which to transmit one or more positioning reference signals for the positioning procedure, and transmits the one or more positioning reference signals to the target UE via the set of time and/or frequency resources.

EP 4057719 A1 discloses a positioning method using a sidelink, and a device. A method of performing positioning through a sidelink by a vehicle terminal can comprise the steps of: receiving a request positioning reference signal (PRS) from a positioning terminal; determining the positioning terminal-based direction angle on the basis of the request PRS; determining a response PRS ID corresponding to the request PRS ID of a request RRS, on the basis of the determined direction angle; and transmitting a response PRS corresponding to the determined response PRS ID. The vehicle terminal is capable of communicating with at least one of another vehicle terminal, a UE related to an autonomous driving vehicle, the BS or a network.

EP 4068810 A1 discloses a method for transmitting and receiving a sidelink positioning reference signal and a terminal. The method includes: when a resource occupied by the sidelink positioning reference signal collides with a resource occupied by at least one type of information in a first information set, not transmitting the S-PRS on the collided resource, wherein the first information set includes: at least one of a sidelink physical channel, a sidelink reference signal, a sidelink synchronization signal, a sidelink synchronization signal block, an automatic gain control information and a guard period information.

US 2022201774 A1 discloses a first user equipment includes: an interface configured to send and receive signals wirelessly; and a processor configured to: establish a sidelink connection with a second user equipment; exchange, using the sidelink connection, sidelink information with the second user equipment to at least one of: transmit, via the interface to the second user equipment, first SL PRS-related data (sidelink positioning reference signal related data) including at least one of first SL PRS assistance data or first SL PRS configuration data; or receive, via the interface from the second user equipment, second SL PRS-related data including at least one of second SL PRS assistance data or second SL PRS configuration data; and exchange, via the interface with the second user equipment using the sidelink connection, one or more sidelink positioning reference signals in accordance with at least one of the first SL PRS-related data or the second SL PRS-related data.

EP 4037226 A1 discloses a signal transmission method and device that can achieve transmission of sidelink positioning reference signals so as to implement sidelink-based positioning. Embodiments of the present application provide a signal sending method used at a sending end, the method comprising: determining sidelink positioning reference signal (SPRS) resource configuration information of a first terminal on a sidelink; and sending, according to the SPRS resource configuration information, a SPRS to a second terminal via the sidelink, such that the second terminal performs positioning measurement on the basis of the SPRS. Well known are metrics and possible countermeasures to reduce channel congestion in SL communication.

SL positioning necessarily involves anchor UE(s) which have knowledge of their own position. In principle, any UE can be an anchor UE for SL positioning if it knows its own position, but currently there is no way for other UE(s) to know if a particular UE is an anchor or not. Common criteria should be defined for a UE to advertise itself as an anchor. These criteria would in general be closely tied to how the resource allocation for SL-PRS is done.

Anchor UE(s) are essential for performing SL positioning. This application gives a solution to the problem of that there is no way of determining which UE(s) are anchors.

### BRIEF DESCRIPTION OF THE FIGURES

FIG. 1 shows gNB assignment to UE as anchor.

FIG. 2 shows UE advertisement as anchor with dedicated RP for positioning.

FIG. 3 shows UE advertisement as anchor with shared RP for positioning in a first embodiment.

FIG. 4 shows UE advertisement as anchor with shared RP for positioning in a second embodiment.

FIG. 5 shows UE advertisement as anchor with shared RP for positioning in a third embodiment.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category Ml, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

For the sake of a better understanding some relevant terms are defined for this application.

Sidelink Channel Occupancy Ratio (SL CR) evaluated at slot n is defined as the total number of sub-channels used for its transmissions in slots [n−a, n−1] and granted in slots [n, n+b] divided by the total number of configured sub-channels in the transmission pool over [n−a, n+b]. a is a positive integer and b is 0 or a positive integer; a and b are determined by UE implementation with a+b+1=1000 or 1000·2μ slots, according to higher layer parameter sl-TimeWindowSizeCR, b<(a+b+1)/2, and n+b shall not exceed the last transmission opportunity of the grant for the current transmission. SL CR is evaluated for each (re)transmission. In evaluating SL CR, the UE shall assume the transmission parameter used at slot n is reused according to the existing grant(s) in slot [n+1, n+b] without packet dropping. The slot index is based on physical slot index. SL CR can be computed per priority level. A resource is considered granted if it is a member of a selected sidelink grant as defined in TS 38.321. Sidelink channel occupancy ratio (SL CR) is applicable for RRC_IDLE intra-frequency, RRC_IDLE inter-frequency, RRC_CONNECTED intra-frequency, RRC_CONNECTED inter-frequency.

SL Channel Busy Ratio (SL CBR) measured in slot n is defined as the portion of sub-channels in the resource pool whose SL RSSI measured by the UE exceed a (pre-)configured threshold sensed over a CBR measurement window [n−a, n−1], wherein a is equal to 100 or 100·2μ slots, according to higher layer parameter sl-TimeWindowSizeCBR. When UE is configured to perform partial sensing by higher layers (including when SL DRX is configured), SL RSSI is measured in slots where the UE performs partial sensing and where the UE performs PSCCH/PSSCH reception within the CBR measurement window. The calculation of SL CBR is limited within the slots for which the SL RSSI is measured. If the number of SL RSSI measurement slots within the CBR measurement window is below a (pre-)configured threshold, a (pre-)configured SL CBR value is used. SL Channel Busy Ratio (SL CBR) is applicable for RRC_IDLE intra-frequency, RRC_IDLE inter-frequency, RRC_CONNECTED intra-frequency, RRC_CONNECTED inter-frequency. The slot index is based on physical slot index.

For the sake of understanding some relevant terms are defined for this application. Target UE means UE to be positioned (in this context, using SL, i.e., PC5 interface), Anchor UE means UE supporting positioning of target UE, e.g., by transmitting and/or receiving reference signals for positioning, providing positioning-related information, etc., over SL interface, Sidelink positioning means: Positioning UE using reference signals transmitted over SL, i.e., PC5 interface, to obtain absolute position, relative position, or ranging information and Ranging means determination of the distance and/or the direction between a UE and another entity, e.g., anchor UE.

The proposed solution presents a method for a UE to advertise itself as an anchor UE based on the congestion control framework and a method for a gNB to assign a UE as an anchor UE. The application enables fast SL-based positioning by quickly identifying anchor UEs.

For gNB assignment to UE as anchor a method is prosed by which a gNB can assign UE(s) as anchor UE(s) for SL positioning. For UE advertisement to other devices as anchor a set of criteria for a UE to decide if it can advertise itself as an anchor for SL positioning is prosed. Furthermore a method by which the UE can advertise itself as an anchor for SL-based positioning is described. The criteria are based on defining new metrics like the SL CBR and SL CR and the indication by the UE is per RP; i.e., if multiple RPs are configured, the UE sends indication as anchor for each RP separately. The metrics and method are different depending on whether the RP is dedicated for positioning or shared for both positioning and communication, e.g., the metrics can be computed separately for communication and non-communication resources in a shared RP, the window size for computation of SL CR and SL CBR given by the parameter a describe 5 paragraph above.

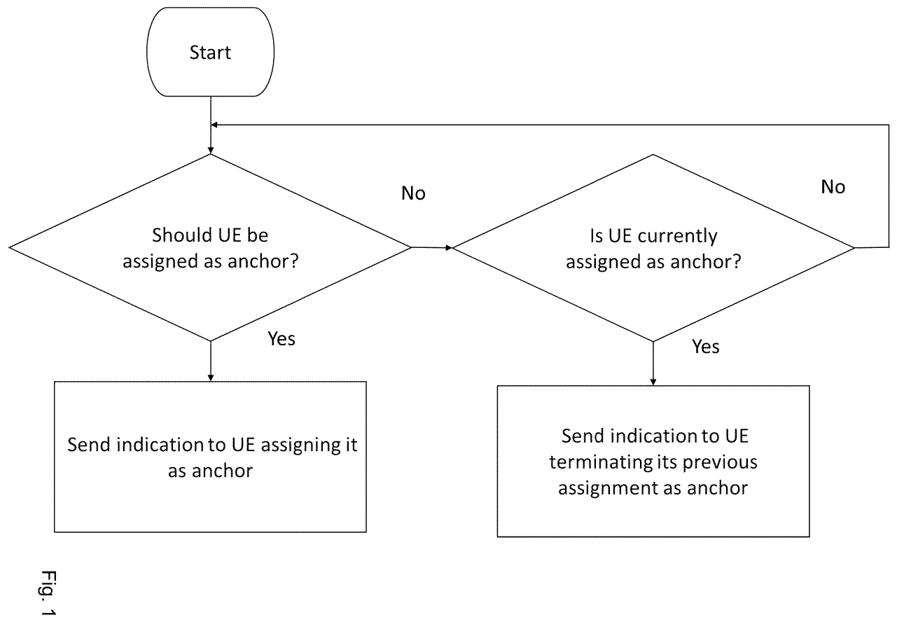

FIG. 1 shows gNB assignment to UE as anchor. The base station (gNB) checks if a UE should be assigned as anchor. This this check result in a yes as indicated in FIG. 1 an indication from base station (gNB) is send to assigning UE as anchor. If this is not the case base station checks if UE is currently assigned as anchor, if this is the case gNB sends indication to UE terminating its previous assignment as anchor.

Based on FIG. 1 gNB can directly assign one or more UE(s) as anchor(s) for SL positioning based on its own evaluation. This assignment can be done for each SL RP separately or for more than one RPs together. Based on e.g., UE capabilities, UE knowledge of current position, etc. the gNB transmits an indication to the UE to become an anchor UE; the indication consists of any combination of the following for a particular RP, or more than one RP:
Fixed number of bits indicating whether the UE is an anchor UE;
Fixed number of bits indicating maximum positioning QoS (service priority) that should be supported by the UE, based on pre-defined QoS table;
Fixed number of bits indicating the lowest priority level of UEs that this UE can be an anchor for;

If the gNB finds that UE is not suitable to be an anchor e.g., if UE's position accuracy is not enough or RP allocation is revoked or there are not many neighboring UEs which may require an anchor, gNB can indicate termination of UE functionality as anchor to the UE dynamically. The indication from gNB can be transmitted along with the grant of the RP in DCI or via MAC CE.

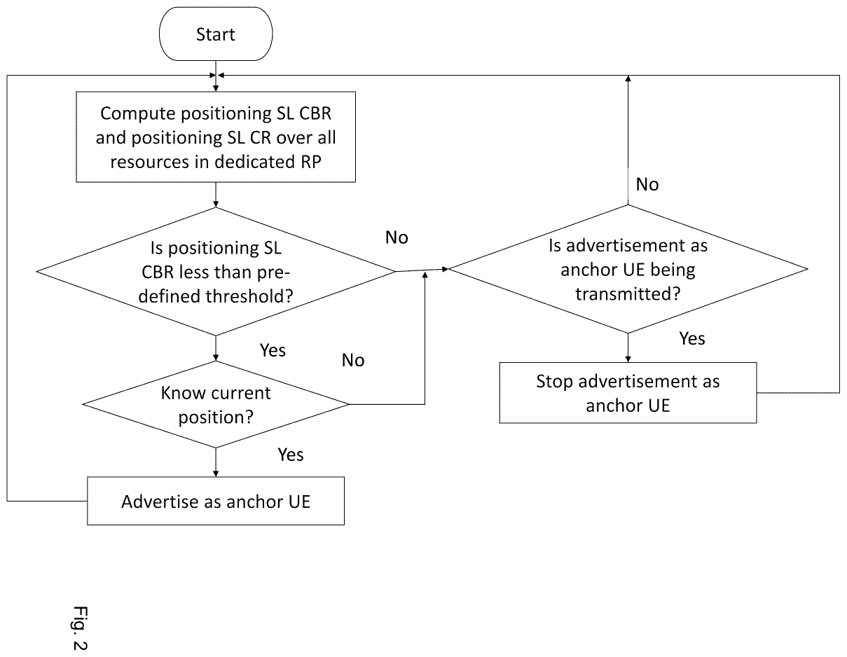

FIG. 2 shows UE advertisement as anchor with dedicated RP for positioning. The user equipment (UE) computes positioning SL CBR and positioning SL CR over all resources in dedicated RP and checks if positioning SL CBR is less than pre-defined threshold. If this is the case the yes condition according to FIG. 2 is fulfilled and the UE checks if it knows the current position. If the current position is known by the UE, it advertises as anchor UE. If the UE figures out that the checkof positioning SL CBR is higher than pre-defined threshold, the UE controls if advertisement as anchor UE is being transmitted. If this check results in a yes like it is depicted in FIG. 2 the UE stops advertisement as anchor UE.

UE evaluates new metrics: positioning SL CBR and positioning SL CR, like the existing SL CR and SL CBR for communication, but defined instead for the dedicated positioning RP and based on an appropriately defined new SL RSSI for the slots configured for positioning. Although the nature of the metrics is similar, they can be computed with different parameters e.g., with a different number of slots given by parameter a like it was already described above. Like the communication SL CBR, the positioning SL CBR is divided into ranges and for each positioning SL CBR range a maximum positioning SL CR limit is specified. UE knows its current position to certain accuracy level; ranges for expected position accuracy from anchor UEs are (pre-)configured along with the assignment of the RP by a gNB/LMF or a UE.

UE advertises itself as an anchor for positioning if both the following conditions are satisfied. The positioning SL CBR is below a certain pre-defined threshold; the threshold is (pre-)configured along with the allocation of the dedicated RP.

The UE knows its current position with a particular accuracy.

In addition to satisfying the above conditions, the UE also evaluates the maximum positioning QoS that can be achieved within the positioning SL CR limit corresponding to the positioning SL CBR range; Maximum positioning QoS is determined based on (pre-)defined QoS thresholds from higher layers and the transmission parameters like SL-PRS power and bandwidth possible within the positioning SL CR limit.

Advertisement as anchor is by transmitting an indication which consists of at least 1-bit indicating UEs' availability as anchor and any combination of the below additional indications. Fixed number of bits indicating the accuracy level of the UEs current known position based on pre-configured accuracy table.

Fixed number of bits indicating maximum positioning QoS (service priority) that can be supported by the UE, based on pre-defined QoS table from higher layers.

Fixed number of bits indicating velocity or mobility level of the UE. Fixed number of bits indicating the lowest priority level of UEs that this UE can be an anchor for.

Indications can be transmitted to other UEs in SL positioning control information like SCI for communication, but defined for positioning in the dedicated RP for positioning or via MAC CE if there is a channel like PSSCH in the dedicated RP.

Indications can be transmitted to gNB in PUCCH as part of UCI or in PUSCH. Target UE or any other device can use these indications to decide whether to choose this anchor UE or not. Positioning SL CBR and positioning SL CR computation and evaluation is performed in each subframe, like SL CBR and SL CR for communication. Advertisement as anchor is stopped if the positioning SL CBR is evaluated to be above the threshold or if the UE's position is not known to the lowest defined accuracy level.

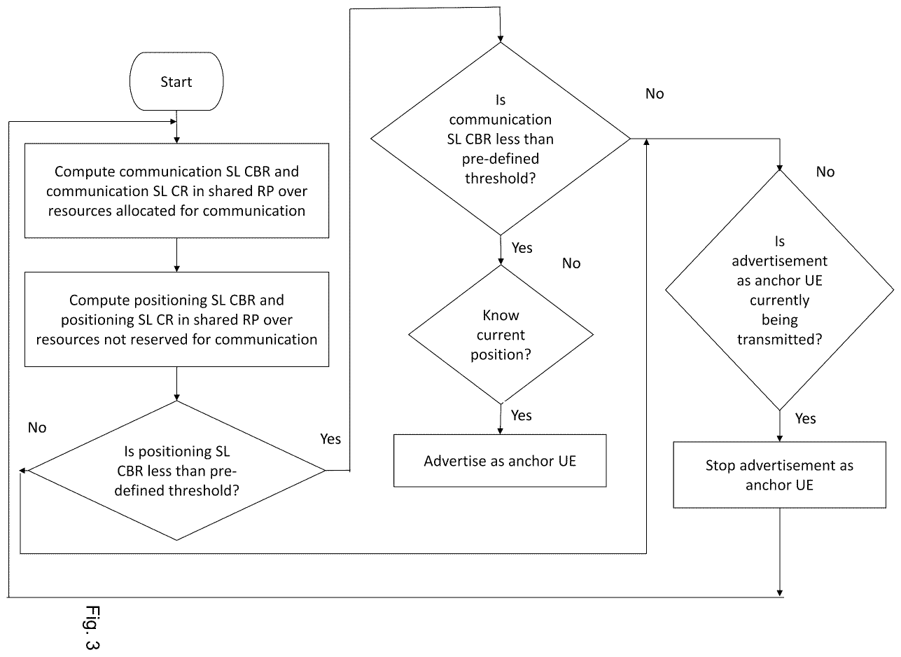

FIG. 3 shows UE advertisement as anchor with shared RP for positioning in a first embodiment. The user equipment (UE) executes separate computation and evaluation of SL CBR and SL CR for positioning and communication. the user equipment (UE) computes communication SL CBR and communication SL CR in shared RP over resources allocated for communication and computes positioning SL CBR and positioning SL CR in shared RP over resources not reserved for communication. The UE checks if the positioning SL CBR is less than pre-defined threshold and if the result of this first check is positive the user equipment (UE) checks if the communication SL CBR is less than pre-defined threshold, if this second check is positive the user equipment (UE) examines if the current own position is known, if this is the case the user equipment (UE) advertises as anchor UE. If the result of the second check is negative and third check is executed and the user equipment (UE) checks if advertisement as anchor UE is currently being transmitted, if this is the case the user equipment (UE) stops advertising as anchor UE.

UE evaluates the SL CR and SL CBR for communication as defined in TS 38.215 over the resources reserved for SL communication and newly defined metrics: positioning SL CR and positioning SL CBR like the SL CR and SL CBR for communication, but defined over the SL resources in the shared RP which are not reserved for communication.

In this first embodiment 1, the metrics are computed separately for the communication and non-communication resources in the shared RP, and hence potentially different parameters can be used for the computation.

The UE advertises itself as anchor if the following conditions are met.
Communication SL CBR is less than pre-defined threshold;
Positioning SL CBR is less than pre-defined threshold;
UE knows its current position with a particular accuracy;
Indication consists of same elements as described in FIG. 2. Advertisement as anchor is by transmitting an indication which consists of at least 1-bit indicating UEs' availability as anchor and any combination of the below additional indications. Fixed number of bits indicating the accuracy level of the UEs current known position based on pre-configured accuracy table. Fixed number of bits indicating maximum positioning QoS (service priority) that can be supported by the UE, based on pre-defined QoS table from higher layers. Fixed number of bits indicating velocity or mobility level of the UE. Fixed number of bits indicating the lowest priority level of UEs that this UE can be an anchor for.

The indication is transmitted in the existing SCI or a positioning SCI or a shared SCI or via MAC CE. The thresholds are (pre-)configured along with the allocation of the shared RP. Advertisement as anchor is stopped if any of the above conditions are not met.

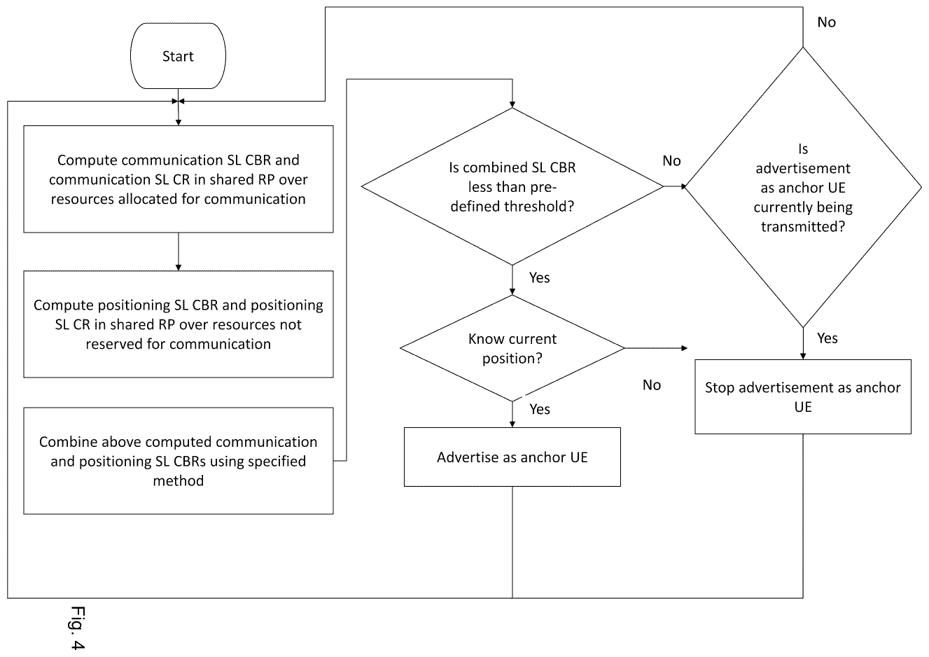

FIG. 4 shows UE advertisement as anchor with shared RP for positioning in a second embodiment. The user equipments (UE) executes separate computation and combined evaluation of SL CBR for communication and SL CBR for positioning, whereby the user equipment (UE) computes communication SL CBR and communication SL CR in shared RP over resources allocated for communication and computes positioning SL CBR and positioning SL CR in shared RP over resources not reserved for communication, combines computed communication and positioning SL CBRs using specified method and the user equipment (UE) checks if the combined SL CBR is less than pre-defined threshold and if the first check result is positive the user equipment (UE) examines if the current own position is known, if this is the case the user equipment (UE) advertises as anchor UE, if the result of the first check is negative the user equipment (UE) checks if advertisement as anchor UE currently is being transmitted, if this second check result is positive the user equipment (UE) stops advertisement as anchor UE.

UE computes the SL CR and SL CBR for communication as defined in TS 38.215 over the resources reserved for SL communication and newly defined metrics: positioning SL CR and positioning SL CBR like the SL CR and SL CBR for communication but defined over the SL resources in the shared RP which are not reserved for communication. Although the nature of the metrics is similar, they can be computed with different parameters e.g., with a different number of slots given by parameter a, which were describe above. UE then combines the communication SL CBR and positioning SL CBR and the communication SL CR and positioning SL CR using a (pre-)defined function e.g., sum of positioning SL CBR and communication SL CBR, sum of positioning SL CR and communication SL CR.

The combined metric for the SL CBR is divided into different ranges which are (pre-)configured and a combined limit is (pre-)defined for the combined SL CR metric. The UE then advertises itself as anchor if the following conditions are met:
Combined SL CBR metric is less than pre-defined threshold
UE knows its current position with a particular accuracy
Indication consists of same elements as described before in FIG. 2. The indication is transmitted in the existing SCI or a positioning SCI or a shared SCI or via MAC CE.

The threshold is (pre-)configured along with the allocation of the shared RP. Advertisement as anchor is stopped if any of the above conditions are not met.

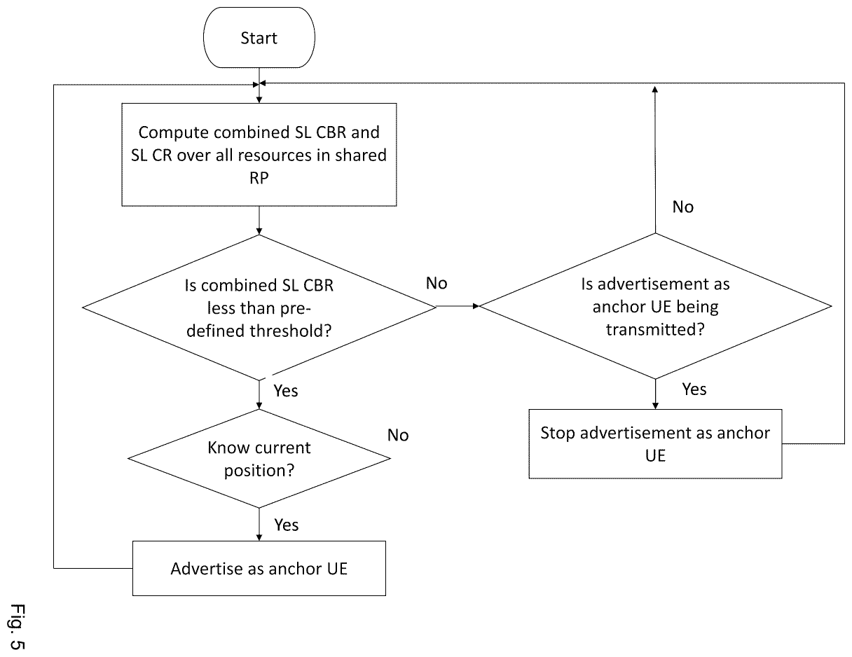

FIG. 5 shows UE advertisement as anchor with shared RP for positioning in a third embodiment. a user equipment (UE) executes combined computation and evaluation of SL CBR and SL CR metrics for positioning and communications, whereby the user equipment (UE) computes combined SL CBR and SL CR over all resources in shared RP, the user equipment (UE) checks if the combined SL CBR is less than pre-defined threshold, if the check result is positive the user equipment (UE) examines if the current own position is known, if this is the case the user equipment (UE) advertises as anchor UE, if the result of the first check is negative if the result of the first check is negative the user equipment (UE) checks if advertisement as anchor UE currently is being transmitted, if this second check result is positive the user equipment (UE) stops advertisement as anchor UE.

UE computes combined SL CR and SL CBR over the shared RP. The combined metric is defined with common parameters over both communication and non-communication resources. Combined SL CBR is divided into different ranges which are (pre-)configured and a limit is (pre-)defined for the combined SL CR metric corresponding to each combined SL CBR range. The UE then advertises itself as anchor if the following conditions are met:
Combined SL CBR metric is less than pre-defined threshold
UE knows its current position with a particular accuracy

Indication consists of same elements as described above. The indication is transmitted in the existing SCI or a positioning SCI or a shared SCI or via MAC CE.

The threshold is (pre-)configured along with the allocation of the shared RP. Advertisement as anchor is stopped if any of the above conditions are not met.

Further embodiment is an apparatus for Sidelink Positioning in a wireless communication system the apparatus comprising a wireless transceiver, a processor coupled with a memory in which computer program instructions are stored, said instructions being configured to implement steps of the claims 1 to 8 and the apparatus is designed for the use in a base station (gNB).

Another embodiment is an apparatus for Sidelink Positioning in a wireless communication system the apparatus comprising a wireless transceiver, a processor coupled with a memory in which computer program instructions are stored, said instructions being configured to implement steps of the claims 9 to 19 and the apparatus is designed for the use in user equipment (UE).

A further embodiment is a base station (gNB) comprising an apparatus according to claim 20.

A further embodiment user equipment comprising an apparatus according to claim 21.

The described components are interacting in a wireless communication system, comprising at least a base station (gNB) according to claim 22 and at least a user equipment (UE) according to claim 23 which is at least configured to act as an anchor UE.

The wireless communications system (which may also be referred to as a wireless wide area network (WWAN)) may include various base stations (gNB) and various UEs. The base stations may include macro cell base stations (high power cellular base stations) and/or small cell base stations (low power cellular base stations). In an aspect, the macro cell base stations may include eNBs and/or ng-eNBs where the wireless communications system corresponds to an LTE network, or gNBs where the wireless communications system corresponds to a NR network, or a combination of both, and the small cell base stations may include femtocells, picocells, microcells, etc.

The base stations may collectively form a RAN and interface with a core network (e.g., an evolved packet core (EPC) or 5G core (5GC)) through backhaul links, and through the core network to one or more location servers which may be part of core network or may be external to core network. In addition to other functions, the base stations may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations may communicate with each other directly or indirectly (e.g., through the EPC/5GC) over backhaul links, which may be wired or wireless.

The base stations may wirelessly communicate with the UEs. Each of the base stations may provide communication coverage for a respective geographic coverage area. In an aspect, one or more cells may be supported by a base station in each geographic coverage area. A “cell” is a logical communication entity used for communication with a base station e.g., over some frequency resource, referred to as a carrier frequency, component carrier, carrier, band, or the like, and may be associated with an identifier e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types e.g., machine-type communication (MTC), narrowband IoT (NB-IoT), enhanced mobile broadband (eMBB), or others that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station e.g., a sector, insofar as a carrier frequency can be detected and used for communication within some portion of geographic coverage areas.

While neighboring macro cell base station geographic coverage areas may partially overlap (e.g., in a handover region), some of the geographic coverage areas may be substantially overlapped by a larger geographic coverage area. For example, a small cell base station (SC) may have a geographic coverage area that substantially overlaps with the geographic coverage area of one or more macro cell base stations. A network that includes both small cell and macro cell base stations may be known as a heterogeneous network. A heterogeneous network may also include home eNBs (HeNBs), which may provide service to a restricted group known as a closed subscriber group (CSG).

The communication links between the base stations and the UEs may include uplink also referred to as reverse link transmissions from a UE to a base station and/or downlink (DL) also referred to as forward link transmissions from a base station to a UE. The communication links may use MIMO antenna technology, including spatial multiplexing, beamforming, and/or transmit diversity. The communication links may be through one or more carrier frequencies. Allocation of carriers may be asymmetric with respect to downlink and uplink e.g., more or less carriers may be allocated for downlink than for uplink.

The wireless communications system may further include a mmW base station that may operate in mmW frequencies and/or near mmW frequencies in communication with a UE. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station and the UE may utilize beamforming (transmit and/or receive) over a mmW communication link to compensate for the extremely high path loss and short range. Further, it will be appreciated that in alternative configurations, one or more base stations may also transmit using mmW or near mmW and beamforming. Accordingly, it will be appreciated that the foregoing illustrations are merely examples and should not be construed to limit the various aspects disclosed herein.

While the disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

The various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Abbreviations

| | |
|---|---|
| BWP | Bandwidth part |
| CBG | Code block group |
| CLI | Cross Link Interference |
| CP | Cyclic prefix |
| CQI | Channel quality indicator |
| CPU | CSI processing unit |
| CRB | Common resource block |
| CRC | Cyclic redundancy check |
| CRI | CSI-RS Resource Indicator |
| CSI | Channel state information |
| CSI-RS | Channel state information reference signal |
| CSI-RSRP | CSI reference signal received power |
| CSI-RSRQ | CSI reference signal received quality |
| CSI-SINR | CSI signal-to-noise and interference ratio |
| CW | Codeword |
| DCI | Downlink control information |
| DL | Downlink |
| DM-RS | Demodulation reference signals |
| DRX | Discontinuous Reception |
| EPRE | Energy per resource element |
| IAB-MT | Integrated Access and Backhaul - Mobile Terminal |
| L1-RSRP | Layer 1 reference signal received power |
| LI | Layer Indicator |
| MCS | Modulation and coding scheme |
| PDCCH | Physical downlink control channel |
| PDSCH | Physical downlink shared channel |
| PSS | Primary Synchronisation signal |
| PUCCH | Physical uplink control channel |
| QCL | Quasi co-location |
| PMI | Precoding Matrix Indicator |
| PRB | Physical resource block |
| PRG | Precoding resource block group |
| PRS | Positioning reference signal |
| PT-RS | Phase-tracking reference signal |
| RB | Resource block |
| RBG | Resource block group |
| RI | Rank Indicator |
| RIV | Resource indicator value |
| RP | Resource Pool |
| RS | Reference signal |
| SCI | Sidelink control information |
| SL CR | Sidelink Channel Occupancy Ratio |
| SL CBR | Sidelink Channel Busy Ratio |
| SLIV | Start and length indicator value |
| SR | Scheduling Request |
| SRS | Sounding reference signal |
| SS | Synchronisation signal |
| SSS | Secondary Synchronisation signal |
| SS-RSRP | SS reference signal received power |
| SS-RSRQ | SS reference signal received quality |
| SS-SINR | SS signal-to-noise and interference ratio |
| TB | Transport Block |
| TCI | Transmission Configuration Indicator |
| TDM | Time division multiplexing |
| UE | User equipment |
| UL | Uplink |

1. A method for Sidelink Positioning in a wireless communication system, characterized by, that a base station (gNB) assigns at least one or more user equipment (UE) as at least one anchor for SL positioning based on the evaluation of the gNB, whereby the gNB checks if the UE should be assigned as an anchor UE based on information available to the gNB; if the check result is positive, the basestation (gNB) sends an indication to the corresponding UE, assigning it as an anchor UE; if the check result is negative the basestation checks if the user equipment (UE) is currently assigned as anchor, if the second checkresult is positive the basestation (gNB) sends indication to UE terminating its previous assignment as anchor.

2. The method according to claim 1, characterized by, that the information available to the gNB are information about UE capabilities and/or the gNB's awareness about the UE's knowledge of the UE's current position.

3. The method according to claim 1, characterized by, that the assignment is done for each SL resource pool (RP) separately or for more than one RPs together.

4. The method according to claim 1, characterized by, base station (gnB) transmits an indication to one or more user equipment (UE) to become an anchor UE.

5. The method according to claim 1, characterized by, the indication consists of a fixed number of bits indicating whether the UE is an anchor UE, in addition to any combination or none of the following, for a particular RP, or more than one RP:
Fixed number of bits indicating maximum positioning QoS or service priority that should be supported by the UE, based on pre-defined QoS table; and
Fixed number of bits indicating the lowest priority level of SL positioning that would be supported by this UE as an anchor.

6. The method according to claim 1, characterized by that, that if the base station (gNB) finds that UE is not suitable to be an anchor gNB indicates termination of UE functionality as anchor to the UE dynamically.

7. The method according to claim 6, characterized by, that if UE's position accuracy is not enough or RP allocation is revoked or there are not many neighboring UEs which may require an anchor, the base station (gNB) finds that UE is not suitable to be an anchor.

8. The method according to claim 1, characterized by, indication from gNB is transmitted along with the grant of the RP in DCI or via MAC CE.

9. A method for Sidelink Positioning in a wireless communication system, characterized by, that a user equipment (UE) computes positioning SL CBR and positioning SL CR over all resources in dedicated RP and checks is positioning SL CBR less than pre-defined threshold, if the first check result is positive the user equipment checks if the UE knows its current position if this second check result is positive the UE advertises as an anchor UE, if the first check result is negative the user equipment checks if the advertisement as anchor UE is being transmitted, if third check result is positive the user equipment (UE) stops advertisement as anchor UE.

10. The method according to claim 9 characterized by, that positioning SL CBR less than threshold or the UE knows current position is sufficient to perform the third check.

11. The method according to claim 9 characterized by, the new metrics are positioning SL CBR and positioning SL CR, and like the existing SL CR and SL CBR for communication, defined instead for the dedicated positioning RP.

12. The method according to claim 9, characterized by, that user equipment UE knows its current position to certain accuracy level; ranges for expected position accuracy from anchor UEs are (pre-)configured along with the assignment of the RP by a gNB/LMF or a UE.

13. The method according to claim 9, characterized by, that a UE advertises as an anchor for SL positioning if the positioning SL CBR is below a certain pre-defined threshold; the threshold is (pre-)configured along with the allocation of the dedicated RP and the UE knows its current position with a particular accuracy.

14. The method according to claim 9, characterized by, the user equipment (UE) can act as an anchor by transmitting an indication which consists of at least 1-bit indicating UEs' availability as anchor and any combination of the additional indications.

15. The method according to claim 9, characterized by, that the additional indications are a fixed number of bits indicating the accuracy level of the UEs current known position based on pre-configured accuracy table and/or a fixed number of bits indicating maximum positioning QoS (service priority) that can be supported by the UE, based on pre-defined QoS table from higher layers and/or fixed number of bits indicating velocity or mobility level of the UE and/or fixed number of bits indicating the lowest priority level of UEs that this UE can be an anchor for.

16. The method according to claim 9, characterized by, the indications are transmitted to other UEs via higher layer messages including SL positioning protocol (SLPP) messages.

17. The method according to claim 9, characterized by, the indications are transmitted to gNB in PUSCH.

18. The method according to claim 9, characterized by, that a target UE or any other device is using the indications to decide whether to choose this anchor UE or not.

19. The method according to claim 9, characterized by, that the advertisement as anchor UE is stopped if the positioning SL CBR is evaluated to be above the threshold or if the UE's position is not known to the lowest defined accuracy level.

20. An apparatus, designed for use in a base station (gNB), for Sidelink Positioning in a wireless communication system the apparatus comprising a wireless transceiver, a processor coupled with a memory in which computer program instructions are stored, said instructions being configured to perform operations comprising: the base station (gNB) assigns at least one or more user equipment (UE) as at least one anchor for SL positioning based on the evaluation of the gNB, whereby the gNB checks if the UE should be assigned as an anchor UE based on information available to the gNB; if the check result is positive, the basestation (gNB) sends an indication to the corresponding UE, assigning it as an anchor UE; if the check result is negative the basestation checks if the user equipment (UE) is currently assigned as anchor, if the second checkresult is positive the basestation (gNB) sends indication to UE terminating its previous assignment as anchor.

21. An apparatus, designed for use in user equipment (UE), for Sidelink Positioning in a wireless communication system, the apparatus comprising a wireless transceiver, a processor coupled with a memory in which computer program instructions are stored, said instructions being configured to perform operations comprising: the user equipment (UE) computes positioning SL CBR and positioning SL CR over all resources in dedicated RP and checks is positioning SL CBR less than pre-defined threshold, if the first check result is positive the user equipment checks if the UE knows its current position if this second check result is positive the UE advertises as an anchor UE, if the first check result is negative the user equipment checks if the advertisement as anchor UE is being transmitted, if third check result is positive the user equipment (UE) stops advertisement as anchor UE.

22. A base station (gNB) comprising an apparatus, designed for use in a base station (gNB), for Sidelink Positioning in a wireless communication system the apparatus comprising a wireless transceiver, a processor coupled with a memory in which computer program instructions are stored, said instructions being configured to perform operations comprising: the base station (gNB) assigns at least one or more user equipment (UE) as at least one anchor for SL positioning based on the evaluation of the gNB, whereby the gNB checks if the UE should be assigned as an anchor UE based on information available to the gNB; if the check result is positive, the basestation (gNB) sends an indication to the corresponding UE, assigning it as an anchor UE; if the check result is negative the basestation checks if the user equipment (UE) is currently assigned as anchor, if the second checkresult is positive the basestation (gNB) sends indication to UE terminating its previous assignment as anchor.

23. A User Equipment comprising an apparatus, designed for use in user equipment (UE), for Sidelink Positioning in a wireless communication system, the apparatus comprising a wireless transceiver, a processor coupled with a memory in which computer program instructions are stored, said instructions being configured to perform operations comprising: the user equipment (UE) computes positioning SL CBR and positioning SL CR over all resources in dedicated RP and checks is positioning SL CBR less than pre-defined threshold, if the first check result is positive the user equipment checks if the UE knows its current position if this second check result is positive the UE advertises as an anchor UE, if the first check result is negative the user equipment checks if the advertisement as anchor UE is being transmitted, if third check result is positive the user equipment (UE) stops advertisement as anchor UE.

24. A wireless communication system, comprising at least a base station (gNB) and at least a user equipment (UE), which is at least configured to act as an anchor UE,
wherein the base station (gNB) comprises a base-station apparatus, designed for use in a base station (gNB), for Sidelink Positioning in a wireless communication system the apparatus comprising a wireless transceiver, a processor coupled with a memory in which computer program instructions are stored, said instructions being configured to perform operations comprising: the base station (gNB) assigns at least one or more user equipment (UE) as at least one anchor for SL positioning based on the evaluation of the gNB, whereby the gNB checks if the UE should be assigned as an anchor UE based on information available to the gNB; if the check result is positive, the basestation (gNB) sends an indication to the corresponding UE, assigning it as an anchor UE; if the check result is negative the basestation checks if the user equipment (UE) is currently assigned as anchor, if the second checkresult is positive the basestation (gNB) sends indication to UE terminating its previous assignment as anchor, and
wherein the at least a User Equipment comprises a User-Equipment apparatus, designed for use in user equipment (UE), for Sidelink Positioning in a wireless communication system, the apparatus comprising a wireless transceiver, a processor coupled with a memory in which computer program instructions are stored, said instructions being configured to perform operations comprising: the user equipment (UE) computes positioning SL CBR and positioning SL CR over all resources in dedicated RP and checks is positioning SL CBR less than pre-defined threshold, if the first check result is positive the user equipment checks if the UE knows its current position if this second check result is positive the UE advertises as an anchor UE, if the first check result is negative the user equipment checks if the advertisement as anchor UE is being transmitted, if third check result is positive the user equipment (UE) stops advertisement as anchor UE.
